(19) United States
(12) Patent Application Publication
(10) Pub. No.: US 2026/0328274 A1
(43) Pub. Date: Oct. 22, 2026

(54) DRIVE ASSEMBLY AND WORK MACHINE

(71) Applicant: DEERE & COMPANY, MOLINE, IL (US)

(72) Inventors: MATTHIAS LANG, MANNHEIM (DE); RAINER GUGEL, PLANKSTADT (DE); DAVID MUELLER, DETTENHEIM (DE); STEFAN RAISCH, VAIHINGEN AN DER ENZ (DE)

(21) Appl. No.: 19/544,560

(22) Filed: Feb. 19, 2026

(30) Foreign Application Priority Data
Apr. 22, 2025 (EP) 25171575.1

(51) Int. Cl. F16H 37/04; F16H 57/02

(52) U.S. Cl. CPC F16H 37/046; F16H 2057/02034; F16H 2057/02056; F16H 2200/0021

(57) ABSTRACT

A drive assembly for a work machine includes a transmission device having first and second input sides and first and second output sides, a dual-clutch transmission connected to the transmission device, the dual-clutch transmission having a first shift element connected to a first transmission input shaft, a second shift element connected to a second transmission input shaft, a plurality of cylindrical gear stages, and a reverse idler gear, an input shaft, an output shaft, a first energy machine connected to the input shaft, a second energy machine connected to the second input side, and a control unit, having a processor and memory, configured to adjust a direction of rotation and a rotating speed of the first output side and the second output side of the transmission device by the second energy machine.

### CROSS-REFERENCE TO RELATED APPLICATIONS

This application claims priority to European Patent Application No. 25171575.1, filed Apr. 22, 2025, which is hereby incorporated by reference.

### FIELD OF THE DISCLOSURE

The disclosure relates to a drive assembly and a work machine.

### BACKGROUND

For a long time, drive assemblies have been used in work machines, in order to be able to vary the propulsion of the work machine without interruption, even under a high towing load, for example caused by a work implement such as a tilling apparatus (e.g. plough) or the like, attached thereto, beyond simply varying the rotational speed of the drive motor. The drive assembly can for example be a power-shiftable drive assembly. A known measure is to increase the number of gear ratio stages of a drive assembly by the latter comprising a combination of transmissions, for example by combining a transmission device with a dual-clutch transmission. DE 10 2013 110 709 A1 discloses such a drive assembly. The dual-clutch transmission used therein may in turn be known from WO 2009/050078 A2.

### SUMMARY

According to an aspect of the present disclosure, a drive assembly for a work machine includes a transmission device including a first input side, a second input side, a first output side, and a second output side, a dual-clutch transmission connected to the transmission device, the dual-clutch transmission including a first shift element connected to a first transmission input shaft, a second shift element connected to a second transmission input shaft, a plurality of cylindrical gear stages each having a fixed gear arranged for conjoint rotation on one of the first or second transmission input shaft, each having a shift gear arranged rotatably on the output shaft, and one of the plurality of cylindrical gear stages having a reverse idler gear, an input shaft, an output shaft, a first energy machine connected to the input shaft, a second energy machine connected to the second input side, and a control unit, including a processor and memory, configured to adjust a direction of rotation and a rotating speed of the first output side and the second output side of the transmission device by the second energy machine.

According to an aspect of the present disclosure, the drive assembly includes a drive unit connected to the input shaft.

According to an aspect of the present disclosure, the transmission device is designed as an epicyclic transmission stage.

According to an aspect of the present disclosure, the epicyclic transmission stage includes a third shift element and a fourth shift element connected to the dual-clutch transmission.

According to an aspect of the present disclosure, the drive assembly includes a set of power electronics by which electrical power is transmissible between the first energy machine and the second energy machine.

According to an aspect of the present disclosure, the drive assembly includes a module for reversing the direction of rotation arranged in the power flux between the transmission device and the dual-clutch transmission.

According to an aspect of the present disclosure, the drive assembly includes a separating clutch is arranged in the power flux between the drive unit and the first energy machine and the transmission device.

According to an aspect of the present disclosure, the input shaft is connected to a first power output.

According to an aspect of the present disclosure, a work vehicle includes any of the embodiments or implementations of the drive assembly disclosed herein.

The above and other features will become apparent from the following detailed description and accompanying drawings.

### BRIEF DESCRIPTION OF THE DRAWINGS

The disclosure and further advantages and advantageous developments and refinements of the disclosure, both in terms of hardware and in terms of method, will be explained in more detail below on the basis of example embodiments and with reference to the drawing. Components with an equivalent or comparable function herein are identified by the same reference signs. In the drawings:

FIG. 1 shows a schematic illustration of a first example embodiment of a work machine according to the disclosure;

FIG. 2 shows a schematic illustration of the first example embodiment of the drive assembly according to the disclosure;

FIG. 3 shows a schematic illustration of a second example embodiment of the drive assembly according to the disclosure;

FIG. 4 shows a schematic illustration of a third example embodiment of the drive assembly according to the disclosure;

FIG. 5 shows a schematic illustration of a fourth example embodiment of the drive assembly according to the disclosure; and

FIG. 6 shows a schematic illustration of a further example embodiment of the dual-clutch transmission.

### DETAILED DESCRIPTION

The embodiments or implementations disclosed in the above drawings and the following detailed description are not intended to be exhaustive or to limit the present disclosure to these embodiments or implementations.

A disadvantage of the known drive assemblies is that an excessive amount of installation space is required. In addition, in recent years, work machines have also become established, for example in the field of agricultural towing vehicles, having drive assemblies which are in the form of continuously variable transmissions. Continuously variable transmissions are conventionally implemented in power-split form with a hydraulically variable path. In order to construct continuously variable transmissions with comfortable shifting operations which are scarcely perceptible, if at all, by the vehicle operator, two variator outputs which are shifted at the synchronization point have to be provided here. This disadvantageously leads to a high degree of complexity in the drive assembly.

Proceeding from this prior art, it is an object of the present disclosure to propose a drive assembly and a work machine that are improved in comparison with the prior art. Specifically, it is an object of the present disclosure to propose a drive assembly and a work machine that are configured structurally more simply and/or more compactly and/or require less construction space and/or less complexity.

This object is achieved by a drive assembly having the features of one or more embodiments disclosed herein and by a work machine having the features of one or more embodiments disclosed herein. One or more embodiments disclosed herein can relate to particularly advantageous embodiments of the disclosure.

Proposed according to the disclosure is a drive assembly for a work machine, for example a continuously variable transmission with an electrically variable path, for example as an input-coupled structure, for a work machine.

The drive assembly comprises:
a transmission device having a first and a second input side, and a first and a second output side, for example having a first and a second input and a first and a second output,
and a dual-clutch transmission, for example having more than one stage, wherein at least one gear is embodied as a winding path gear, and the dual-clutch transmission is connectable, or connected, for example on the input side, to the transmission device,
and an input shaft, wherein for example the first input side can be connectable or connected to the input shaft,
and an output shaft,
and a first energy machine, the first energy machine being connectable or connected to the input shaft,
and a second energy machine, the second energy machine being connectable or connected to the second input side.

A rotating speed and/or a direction of rotation, and/or for example a rotation, of the transmission device is settable and/or adjustable and/or actuable, for example a rotating speed and/or a direction of rotation, and/or for example a rotation, of the first and/or the second output side, for example of the first or the second output side, of the transmission device, is settable and/or adjustable and/or actuable by the second energy machine. In other words, a rotating speed and/or a direction of rotation, and/or for example a rotation, of the second energy machine can be settable and/or adjustable and/or actuable, for example in such a manner that a rotating speed and/or a direction of rotation, and/or for example a rotation, of the first and/or the second output side, for example of the first or the second output side, of the transmission device is settable and/or adjustable and/or actuable. Alternatively or in addition, the drive assembly and/or the work machine can comprise a control unit. The control unit can be configured to set and/or adjust and/or actuate a rotating speed and/or a direction of rotation, and/or for example a rotation, of the first and/or the second output side, for example of the first or the second output side, of the transmission device, for example to set and/or adjust and/or actuate a rotating speed and/or a direction of rotation, and/or for example a rotation, of the first and/or the second output side, for example of the first or the second output side, of the transmission device by the second energy machine. Specifically, the control unit can be configured to set and/or adjust and/or actuate a rotating speed and/or a direction of rotation, and/or for example a rotation, of the second energy machine, in order to set and/or adjust and/or actuate a rotating speed and/or a direction of rotation, and/or for example a rotation, of the first and/or the second output side, for example of the first or the second output side, of the transmission device.

“Connected” can for example be understood as mechanically connected and/or mechanically operatively connected and/or connected for conjoint rotation. Specifically, “connected” can additionally or alternatively be understood as drivably connected, i.e. connected torque-transmittingly and/or so as to transmit rotational speed, and/or coupled, i.e. for example mechanically coupled and/or rigidly coupled, and/or coupled for conjoint rotation. “Connectable” can for example be understood as mechanically connectable and/or mechanically operatively connectable and/or connectable for conjoint rotation. Specifically, “connectable” can additionally or alternatively be understood as drivably connectable, i.e. connected torque-transmittingly and/or so as to transmit rotational speed, and/or couplable, i.e. mechanically couplable and/or rigidly couplable, and/or connectable for conjoint rotation. “Connected” can thus specifically be understood to mean a connection between two components, which enables energy and/or force and/or a torque and/or a rotational speed to be transmitted from the one component to the other component, for example by mechanical means. Further components or parts enabling such a transmission of energy and/or force and/or torque and/or transmission of a rotational speed between the two components can be provided between the two components.

The first and/or second energy machine can be realized in a countershaft design or in an inline design, for example can be arranged in the drive assembly in a countershaft design or in an inline design. The first and/or second energy machine can be designed as electric motors, for example as a first and second electric motor. Alternatively or in addition, the first and/or second energy machine can be designed as a fuel cell, for example as a first and second fuel cell, or can comprise said fuel cell. However, the first and/or the second energy machine can also be a permanent-magnet and/or electrically excited synchronous and/or asynchronous machine that is operated using direct current and/or three-phase current, for example a permanent-magnet three-phase synchronous machine. The first and the second energy machine can be operable as motors and/or as generators. The first and the second energy machine can drive the drive assembly with a rotational speed and/or a force and/or a torque. The first energy machine, for example the first electric motor, can comprise a first drive shaft. The second energy machine, for example the second electric motor, can comprise a second drive shaft. The first and the second energy machine can be operable at each operating point, the one as a motor and the other as a generator. The control unit can be configured to operate the first and the second energy machine at each operating point, the one as a motor and the other as a generator. The control unit can be configured to set and/or adjust and/or control the first and second energy machine at each operating point, for example in such a way that the one is operated as a motor and the other as a generator.

The first energy machine can be connected on the driven side to the input shaft. For this purpose, a rotor of the first energy machine, for example an internal rotor, can be connected to the input shaft, for example. The first energy machine can be embodied as a torque motor. In this embodiment, the first energy machine drives the input shaft directly. Equally, however, the first energy machine can also be connected to the input shaft directly or via or with a first or by a first transmission stage, for example a cylindrical gear stage or a gearwheel pair or a planetary set, or a transmission and/or a further shaft. The first energy machine can thus be connected to the input shaft with a fixed transmission ratio or with a variable transmission ratio. The first energy machine can also be designed as a generator and can charge an energy store, for example in a regeneration mode.

The second energy machine can be connected on the driven side to the second input side of the transmission device. For this purpose, a rotor of the second energy machine, for example an internal rotor, can be connected to the second input side, for example. The second energy machine can be embodied as a torque motor. Equally, however, the second energy machine can also be connected to the second input side directly or via or with a second or by a second transmission stage, for example a cylindrical gear stage or a gearwheel pair or a planetary set, or a transmission and/or a further shaft. The second energy machine can thus be connected to the second input side with a fixed transmission ratio or with a variable transmission ratio, e.g. via the transmission. The second energy machine can also be designed as a generator and can charge the energy store, for example in a regeneration mode.

The drive assembly, for example the work machine, can comprise one or more energy stores. The energy store can be electrically connected and/or electrically couplable to the first and/or the second energy machine. The energy store can be an electrical energy store. The energy store can supply the first and/or the second energy machine with energy, for example electrical energy, and/or power, for example electrical power. The energy store can be charged, for example with energy, for example electrical energy, and/or can be supplied with power, for example electrical power, by the first and/or the second energy machine. The energy store can be designed as a battery and/or a rechargeable battery and/or a supercapacitor and/or a fuel cell and/or any other device for storing electrical energy.

An input side, for example the first and/or the second input side, can be a mechanical interface with which a force and/or a torque and/or a rotational speed can be introduced into the drive assembly, for example into the transmission device and/or the dual-clutch transmission. An output side, for example the first and/or the second output side and/or the output shaft, can be a mechanical interface with which a force and/or a torque and/or a rotational speed can be discharged from the drive assembly, for example from the transmission device and/or the dual-clutch transmission.

The dual-clutch transmission can comprise a first shift element, for example a first clutch, and a second shift element, for example a second clutch. The input side or the input sides of the first and/or the second shift element, for example of the first and the second clutch, can be a third input side. The third input side of the dual-clutch transmission can be connectable or connected, for example directly or indirectly, to the first and/or the second output side of the transmission device. The first shift element, for example the first clutch, can be connectable or connected to a first transmission input shaft of the dual-clutch transmission, and the second shift element, for example the second clutch, can be connectable or connected to a second transmission input shaft of the dual-clutch transmission. The dual-clutch transmission can be mounted in the power flow downstream of the transmission device. Specifically, the first and/or the second output side can be connectable or connected to the first transmission input shaft by way of or by the first shift element, and/or to the second transmission input shaft by way of or by the second shift element. The first and/or the second shift element, for example the first and/or the second clutch, and/or the first and/or the second transmission input shaft, can be arranged so as to be axially parallel to and/or coaxial with one another.

The first shift element, for example the first clutch, can be movable and/or shiftable between an open state, in which no rotational speed and/or torque is transmitted to the first transmission input shaft, and a closed state, in which a rotational speed and/or a torque is transmitted to the first transmission input shaft. Specifically, the first shift element, for example the first clutch, can be movable and/or shiftable between an open state, in which the first output side is released in terms of drive from the first transmission input shaft, and a closed state, in which the first output side is in drive connection with, i.e. is connected to, the first transmission input shaft. The second shift element, for example the second clutch, can be movable and/or shiftable between an open state, in which no rotational speed and/or torque is transmitted to the second transmission input shaft, and a closed state, in which a rotational speed and/or a torque is transmitted to the second transmission input shaft. Specifically, the second shift element, for example the second clutch, can be movable and/or shiftable between an open state, in which the first output side is released in terms of drive from the second transmission input shaft, and a closed state, in which the first output side is in drive connection with, i.e. is connected to, the second transmission input shaft.

The first and/or the second transmission input shaft can be connectable or connected to the output shaft, for example the dual-clutch transmission, via a plurality of cylindrical gear stages of the dual-clutch transmission. In other words, the dual-clutch transmission can comprise one or more cylindrical gear stages, for example a plurality of cylindrical gear stages. The first and/or the second transmission input shaft can be connectable or connected to the output shaft via the one or more or by the one or more cylindrical gear stages, for example for setting up gear ratio stages. A cylindrical gear stage can comprise a fixed gear arranged on the first or the second transmission input shaft for conjoint rotation and a shift gear arranged rotatably on the output shaft. Alternatively, a cylindrical gear stage can comprise a fixed gear arranged on the output shaft for conjoint rotation and a shift gear arranged rotatably on the first or the second transmission input shaft.

The first input side can comprise a first drive element or be configured as a first drive element. The second input side can comprise a second drive element or be configured as a second drive element. The first and/or the second input side, for example the first and/or the second drive element, can be configured, for example, as a shaft and/or can comprise the latter. The first output side can comprise a first driven element or be configured as a first driven element. The second output side can comprise a second driven element or be configured as a second driven element. The first output side, for example the first driven element, can, for example, be configured as a shaft and/or can comprise the latter. The second output side, for example the second driven element, can, for example, be configured as a shaft and/or can comprise the latter.

The drive assembly can comprise a starting module for electric starting. The starting module can be arranged in the power flow between the first energy machine and the transmission device or can be arranged in the power flow between the first energy machine and a module for reversing the direction of rotation or can be arranged in the power flow between the module for reversing the direction of rotation and the transmission device or in the power flow between the first energy machine and the transmission device. For the optional coupling and decoupling of a drive connection, the starting module for electric starting can be formed between:
the first energy machine and the transmission device, or
the first energy machine and the module for reversing the direction of rotation, or
the module for reversing the direction of rotation and the transmission device, or
the first energy machine and the transmission device.

The starting module can have a further shift element which can be connectable or connected to the above-mentioned assemblies on the drive side and driven side, for example via shafts.

The shift elements, for example the first and/or the second and/or a third and/or a fourth shift element, and/or the further shift elements and/or a separating clutch and/or a clutch device, can be connected to the control unit for signalling and/or operatively coupled thereto and/or connected thereto for transmitting signals and/or carrying data. Specifically, each shift element can comprise a valve or a valve assembly, for example a control valve, or an actuator for controlling and/or setting and/or adjusting the respective assigned shift element. The valve or the valve assembly or the actuator can be connected and/or operatively coupled to the respective assigned shift element. The control unit can be connected to the valve or the valve assembly or to the actuator of the respective assigned shift element for signalling and/or operatively coupled thereto and/or connected thereto for transmitting signals and/or carrying data. The control unit can be configured to control and/or set and/or adjust the shift element, for example via or with the respective assigned valve or the valve arrangement or the actuator. The control unit can be configured to set and/or adjust the shift element, for example via the or with the respective assigned valve or the valve assembly or the actuator, to the first position, i.e. the open state, or the second position, i.e. the closed state, for example also to move same from the first position into the second position, and vice versa.

The “shift element”, for example the first and/or the second and/or a third and/or a fourth shift element, and/or the further shift elements and/or the separating clutch and/or the clutch device, can be understood to mean a connecting part by means of which at least one part which transmits energy and/or force and/or a torque and/or a rotating speed is connectable effectively in terms of drive to a further part which transmits energy and/or force and/or a torque and/or a rotating speed or to a part which is fixed in a location or on the housing. The respective shift element is shiftable between at least an open state and a closed state, wherein, in the open state, the shift element cannot transmit either energy and/or force and/or a torque and/or a rotational speed between two parts that interact with the shift element, and wherein, in the closed state, the shift element can transmit energy and/or force and/or a torque and/or a rotational speed between the two parts that interact with the shift element. If there is a connection, for example an operative connection, between two elements or components of the drive assembly, energy and/or force and/or a torque and/or rotational speed are/is transmitted from one element or one component to the other element or the other component. The shift element, for example the first and/or second and/or a third and/or fourth shift element and/or further shift elements and/or the separating clutch and/or clutch device can be a clutch, for example a multi-disc clutch, and/or a brake and/or a synchronization mechanism and/or a dog clutch. Specifically, the first and/or the second and/or a third and/or a fourth shift element and/or further shift elements and/or the separating clutch and/or the clutch device can be designed as multi-disc clutches (or as dry single-disc clutches), for example as friction clutches. However, the first and/or the second and/or a third and/or a fourth shift element and/or further shift elements and/or the separating clutch and/or the clutch device can also be designed as non-powershift clutches.

According to some embodiments, a rotating speed and/or a direction of rotation, and/or for example a rotation, of the first and/or the second output side of the transmission device is settable and/or adjustable and/or actuable. As a result, a battery-electric travel range can advantageously be implemented. By combining the dual-clutch transmission with the transmission device, for example an electrically power-branched epicyclic transmission stage as part of a dual variator with two output sides, the power to be installed of the energy machine can be reduced in such a way that the required installation space of the drive assembly can be reduced. In addition, the drive assembly has significantly more gears and thus provides a greater transmission spread. Furthermore, the drive assembly can advantageously be realized as a power-shiftable seamless continuously variable transmission with an electrically variable path, wherein the gear change can take place in the case of rotational speed equality of all the components involved (so-called true seamless shifts).

In a refinement of the disclosure, the drive assembly comprises a drive unit. The drive unit is connected to the input shaft. The input shaft can be connectable or connected to the first input side. The drive unit and/or the first energy machine can be connectable or connected to the first input side of the transmission device via the or by the input shaft. The drive unit can be designed as an internal combustion engine. Alternatively or additionally, the drive unit can be an electric motor. The first energy machine can be in a constant rotational speed ratio with the drive unit. The second energy machine can be in a constant torque ratio with the drive unit.

With this design embodiment of the drive assembly, a rotating speed and/or a direction of rotation, and/or for example a rotation, of the drive unit and/or the input shaft in or with the transmission device can be superimposed in such a way that a rotating speed and/or a direction of rotation, and/or for example a rotation of the first and/or the second output side, for example of the first or the second output side, of the transmission device is settable and/or adjustable and/or actuable, for example settable and/or adjustable counter to the rotating speed and/or direction of rotation, and/or for example rotation, of the drive unit and/or input shaft, for example the direction of rotation of the first and/or the second output side, for example of the first or the second output side, is settable and/or adjustable counter to the direction of rotation of the drive unit and/or the input shaft. In other words, the rotating speed and/or direction of rotation, and/or for example rotation, of the drive unit and/or the input shaft can be superimposed in or with the transmission device with the rotating speed and/or direction of rotation, and/or for example rotation, of the second energy machine, for example in such a manner that a rotating speed and/or a direction of rotation, and/or for example a rotation, of the first and/or the second output side, for example of the first or the second output side, of the transmission device is settable and/or adjustable and/or actuable, for example settable and/or adjustable counter to the rotating speed and/or direction of rotation, and/or for example rotation, of the drive unit and/or the input shaft, for example the direction of rotation of the first and/or the second output side, for example of the first or the second output side, is settable and/or adjustable counter to the direction of rotation of the drive unit and/or the input shaft. Specifically, the rotating speed and/or direction of rotation, and/or for example rotation, of the second energy machine is able to be set and/or adjusted and/or actuated in such a manner, and able to be superimposed in or with the transmission device with the rotating speed and/or direction of rotation, and/or for example rotation, of the drive unit and/or the input shaft in such a manner, that a rotating speed and/or a direction of rotation, and/or for example a rotation, of the first and/or the second output side, for example of the first or the second output side, of the transmission device is settable and/or adjustable and/or actuable, for example settable and/or adjustable counter to the rotating speed and/or direction of rotation, and/or for example rotation, of the drive unit and/or the input shaft, for example the direction of rotation of the first and/or the second output side, for example of the first or the second output side, is settable and/or adjustable counter to the direction of rotation of the drive unit and/or input shaft. As a result, reverse operation of the drive assembly and/or reverse travel of the work machine can be made possible. Alternatively or additionally, the control unit can be configured to superimpose a rotating speed and/or a direction of rotation, and/or for example a rotation, of the drive unit and/or the input shaft in or with the transmission device, and to set and/or to adjust and/or to actuate a rotating speed and/or a direction of rotation, and/or for example a rotation, of the first and/or the second output side, for example of the first or the second output side, of the transmission device, for example to set and/or to adjust same in the opposite direction to the rotating speed and/or direction of rotation, and/or for example rotation, of the drive unit and/or the input shaft, for example to set and/or adjust the direction of rotation of the first and/or the second output side, for example of the first or the second output side, in the direction counter to the direction of rotation of the drive unit and/or the input shaft. In other words, alternatively or additionally, the control unit can be configured to superimpose the rotating speed and/or direction of rotation, and/or for example rotation, of the drive unit and/or the input shaft in or with the transmission device with the rotating speed and/or direction of rotation, and/or for example rotation, of the second energy machine, and to set and/or to adjust and/or to actuate a rotating speed and/or a direction of rotation, and/or for example a rotation, of the first and/or the second output side, for example of the first or the second output side, of the transmission device, for example to set and/or to adjust same in the direction counter to the rotating speed and/or direction of rotation, and/or for example rotation, of the drive unit and/or the input shaft, for example to set and/or adjust the direction of rotation of the first and/or the second output side, for example of the first or the second output side, counter to the direction of rotation of the drive unit and/or the input shaft. Specifically, alternatively or additionally, the control unit can be configured to set and/or to adjust and/or to actuate the rotating speed and/or direction of rotation, and/or for example rotation, of the second energy machine and to superimpose the rotating speed and/or direction of rotation, and/or for example rotation, of the second energy machine in or with the transmission device with the rotating speed and/or direction of rotation, and/or for example rotation, of the drive unit and/or the input shaft in order to set and/or to adjust and/or to actuate a rotating speed and/or a direction of rotation, and/or for example a rotation, of the first and/or the second output side, for example of the first or the second output side, of the transmission device, for example to set and/or adjust same in the direction counter to the rotating speed and/or direction of rotation, and/or for example rotation, of the drive unit and/or the input shaft, for example to set and/or to adjust the direction of rotation of the first and/or the second output side, for example of the first or the second output side, in the direction counter to the direction of rotation of the drive unit and/or the input shaft. As a result, reverse operation of the drive assembly and/or reverse travel of the work machine can be made possible.

According to some embodiments, by combining the drive unit with the transmission device and the dual-clutch transmission, setting and/or adjusting, and/or for example reversing, of the direction of rotation of the first and/or the second output side of the transmission device can be implemented. The drive assembly can thus be realized as a power-shiftable continuously variable transmission with an electrically variable path. Advantageously, the power to be installed of the first and second energy machines can be reduced. Moreover, the required installation space can be reduced. It is thereby advantageously possible to achieve a construction of the drive assembly that is simple in design and compact. As a result, the drive device, for example also the work machine, can advantageously be able to be driven in a hybrid manner.

In a refinement of the disclosure, the dual-clutch transmission comprises the first and second shift element, wherein the first shift element is connected to the first transmission input shaft and the second shift element is connected to the second transmission input shaft. The dual-clutch transmission can comprise one or more cylindrical gear stages each having a fixed gear arranged on the first or second transmission input shaft for conjoint rotation and each having a shift gear arranged rotatably on the output shaft and/or one or more cylindrical gear stages each having a fixed gear arranged on the output shaft for conjoint rotation and each having a shift gear arranged rotatably on the first or second transmission input shaft. The shift gears, for example gearwheels or gear-ratio gearwheels, can be arranged and/or mounted, for example rotatably arranged and/or rotatably mounted, on the output shaft and/or on the first and/or second transmission input shaft. Fixed gears, for example gearwheels, can be arranged on the first and/or second transmission input shaft and/or on the output shaft, for example arranged for conjoint rotation, and/or connected to the output shaft. The fixed gears can be in engagement with the shift gears.

The drive assembly, for example the dual-clutch transmission, can have a plurality of cylindrical gear stages, for example at least two, four, or precisely four, or more cylindrical gear stages, for setting up gear ratio stages, for example group gear ratio stages. Specifically, a first cylindrical gear stage and a second cylindrical gear stage can each have the fixed gear on the first transmission input shaft and can each have the shift gear on the output shaft. A third cylindrical gear stage and a fourth cylindrical gear stage can each have the fixed gear on the second transmission input shaft and can each have the shift gear on the output shaft. Furthermore, the dual-clutch transmission can comprise one or more coupling elements for coupling two shift gears, wherein for example the coupling element or the coupling elements can be rotatably mounted on the output shaft, or can be connected to the output shaft not for conjoint rotation. The shift gear of the second cylindrical gear stage and the shift gear of the third cylindrical gear stage can be couplable, for example selectively couplable, by a first coupling element in such a way that at least one winding path gear ratio stage is able to be formed via the second and the third cylindrical gear stages. In this respect, the shift gear of the second cylindrical gear stage and the shift gear of the third cylindrical gear stage can be couplable for example in combination with the first or the fourth cylindrical gear stage, that is to say for example when the first or the fourth cylindrical gear stage is also fixed or coupled by further coupling elements to the output shaft for conjoint rotation. In other words, the shift gear of the second cylindrical gear stage and the shift gear of the third cylindrical gear stage and the first coupling element can be arranged on the output shaft in such a way, and for example the shift gear of the second cylindrical gear stage and the shift gear of the third cylindrical gear stage can be connectable and releasable by means of the first coupling element in such a way, that at least one winding path gear ratio stage is shiftable via the first coupling element. The power flow of the winding path gear ratio stage here can run over at least three cylindrical gear stages having mutually meshing fixed gears and shift gears. The highest gear ratio stage and the lowest gear ratio stage can be implemented as winding path gear ratio stages. According to some embodiments, the dual-clutch transmission can include only six gear ratio stages, for example only six power-shiftable gear ratio stages.

On the driven side, the output shaft can be assigned to the dual-clutch transmission. The dual-clutch transmission can be connected on the input side to the first output side, for example to the first ring gear or the first planet carrier or a sun, for example the third sun, of the second planetary transmission, for example via a shaft. The first and/or the second transmission input shaft can be brought into driving connection with the output shaft. The first and/or the second transmission input shaft can be in the form of hollow shafts. The input shaft can be designed as a solid shaft. Moreover, the input shaft and/or the first and/or the second transmission input shaft can be arranged coaxially with one another and/or one in the other, for example one in the other so as to be able to freely rotate. Specifically, the second transmission input shaft can be arranged and/or mounted in the first transmission input shaft, for example arranged so as to be able to freely rotate and/or mounted so as to be able to freely rotate. Moreover, the input shaft can be arranged and/or mounted in the second transmission input shaft, for example arranged so as to be able to freely rotate and/or mounted so as to be able to freely rotate.

The dual-clutch transmission can moreover comprise the first coupling element. The first coupling element can for example be designed to couple the shift gears of the second and the third cylindrical gear stage. For this purpose, the first coupling element can be arranged on the output shaft between the second and the third cylindrical gear stages, and for example mounted on the output shaft. The two shift gears can be connectable to the first coupling element for conjoint rotation and so as to be releasable, the two coupled shift gears for example being able to be rotatably and/or loosely arranged on the output shaft. In this context, the two rotatably mounted shift gears of the second and the third cylindrical gear stages can be couplable via the first coupling element in such a way that a connection between the two shift gears for conjoint rotation is able to be established as a function of a shifting state of the first coupling element. In other words, the two shift gears can be connected to the first coupling element in such a way that the first and the second transmission input shafts are placed in dependence on one another. Specifically, in the case of a winding path gear ratio stage, the shift gear of the second cylindrical gear stage and the shift gear of the third cylindrical gear stage are thus coupled to one another in order to implement a common force flow and power flow through the first and the second transmission input shaft as a result.

Specifically, the dual-clutch transmission can comprise precisely two transmission input shafts, the first and the second transmission input shaft, precisely the output shaft, and precisely the first and the second shift element. Moreover, the dual-clutch transmission can comprise precisely four cylindrical gear stages. The first cylindrical gear stage can comprise a first fixed gear which is arranged for example at or on the first transmission input shaft and which can engage with a first shift gear which is arranged for example at or on the output shaft. The second cylindrical gear stage can comprise a second fixed gear which is arranged for example at or on the first transmission input shaft and which can engage with a second shift gear which is arranged for example at or on the output shaft. The third cylindrical gear stage can comprise a third fixed gear which is arranged for example at or on the second transmission input shaft and which can engage with a third shift gear which is arranged for example at or on the output shaft. The fourth cylindrical gear stage can comprise a fourth fixed gear which is arranged for example at or on the second transmission input shaft and which can engage with a fourth shift gear which is arranged for example at or on the output shaft. A winding path gear stage can be shiftable in that two of the shift gears, thus for example the second and the third shift gear, are co-rotationally connected by the first coupling element, and simultaneously the first or the fourth spur gear stage are activated, thus simultaneously the first shift gear is connected by a second coupling element, or the fourth shift gear is connected by a third coupling element, to the output shaft. As a result, two gear ratio stages can be realized as winding path gear ratio stages. The dual-clutch transmission can thus specifically comprise six gear ratio stages or group gear ratio stages, which for example are power-shiftable. The dual-clutch transmission can have four gear ratio stages which are shiftable only via one cylindrical gear stage and, in addition, two gear ratio stages which are shiftable as winding path gear ratio stages.

The first coupling element can be movable between a first shift position, in which the shift gear of the second cylindrical gear stage and the shift gear of the third cylindrical gear stage are coupled, and a second shift position, in which the shift gear of the second cylindrical gear stage and the shift gear of the third cylindrical gear stage are released from one another. The shift gears can be connectable by the first and/or second and/or third coupling element to the output shaft for conjoint rotation and so as to be releasable; for example, in each case one of the shift gears can be connectable by one of the coupling elements to the output shaft for conjoint rotation and so as to be releasable. The coupling elements can be mounted on the output shaft for conjoint rotation and so as to be axially displaceable, and/or can be movable, for example axially movable, by means of one or more actuating elements. The coupling elements can be arranged between in each case two shift gears, wherein for example the fixed gears associated with the shift gears are arranged on the same transmission input shaft, i.e. on the first or the second transmission input shaft. The first coupling element can be arranged between the second and the third cylindrical gear stage on or at the output shaft. The second coupling element can be arranged between the first and the second cylindrical gear stage on or at the output shaft. The third coupling element can be arranged between the third and the fourth cylindrical gear stage on or at the output shaft. The first and/or second and/or third coupling element can be designed in a form known per se as dog clutches or as actuating apparatuses, for example sliding sleeves, and shift assemblies, comprising synchronizing rings, or synchronizers. In any case, the coupling elements are coupling means which are arranged on the output shaft for conjoint rotation and so as to be axially displaceable and by means of which the shift gears are connectable to the output shaft for conjoint rotation for the purpose of activating a transmission ratio. The coupling elements can be axially displaced via the actuating element or elements. For this purpose, the drive assembly can comprise corresponding actuating elements or for example each coupling element can comprise a respective actuating element. The shift assemblies or synchronizers can comprise actuating apparatuses or sliding sleeves that are axially displaceable on the output shaft but are connected to the output shaft for conjoint rotation, and synchronizing rings that are axially directly adjacent, i.e. arranged on the right and/or left of the actuating apparatus or the sliding sleeve. To actuate the coupling elements, the actuating apparatus, the sliding sleeve or the actuating element can be actuable manually or with power assistance. For this purpose, the drive assembly can comprise, for example, one or more actuators so that the actuating apparatus or actuating element is actuable with power assistance.

In a refinement of the disclosure, one of the cylindrical gear stages comprises a return gear. The drive assembly, for example the dual-clutch transmission, for example one of the cylindrical gear stages, can comprise the return gear. The return gear can be arranged, for example interposed, between one of the first or second transmission input shafts and the output shaft. The return gear can be arranged between a fixed gear and a shift gear of the cylindrical gear stage. As a result, in each case the fixed gear and the return gear and the shift gear and the return gear can be in engagement with one another. Specifically, the first or second or third or fourth cylindrical gear stage can comprise the return and/or the return gear can be arranged therein. Specifically, the return gear can be arranged in the first or fourth cylindrical gear stage, for example between the fixed gear and the shift gear of the first or fourth cylindrical gear stage. As a result, it is advantageously possible with the drive assembly, for example the dual-clutch transmission, to realize four forward gears (of which one is a winding path gear) and two reverse gears (of which one is a winding path gear). Alternatively, the return gear can be arranged in the second or third cylindrical gear stage, for example between the fixed gear and the shift gear of the second or third cylindrical gear stage. As a result, with the drive assembly, for example the dual-clutch transmission, it is advantageously possible for three forward gears to be in the form of single-stage gears and three reverse gears, of which two are in the form of winding path gears, to be realized.

In a refinement of the disclosure, the transmission device is designed as an epicyclic transmission stage. The transmission device can be designed as a mechanical epicyclic transmission stage, for example an electrically power-split epicyclic transmission stage. The transmission device, for example the epicyclic transmission stage, can comprise a planetary coupling transmission, for example exactly one planetary coupling transmission.

The transmission device, for example the epicyclic transmission stage, for example the planetary coupling transmission, can comprise at least one, or exactly one, first and at least one, or exactly one, second planetary transmission. The first and the second planetary transmission can be coupled to one another. In other words, the transmission device, for example the epicyclic transmission stage, for example the planetary coupling transmission or the first and the second planetary transmissions, can have four shafts leading to the outside, of which one shaft is connected to the second energy machine and one shaft is connected to the drive unit and/or to the first energy machine. The two remaining shafts can be embodied as the first and the second output side and/or the first and the second output side can comprise the two remaining shafts.

The transmission device, for example the epicyclic transmission stage, for example the planetary coupling transmission or the first and the second planetary transmission, can also be designed as a dual planet carrier transmission. The transmission device, for example the epicyclic transmission stage, for example the planetary coupling transmission, can be designed as a Ravigneaux gear set and/or as a Lepelletier transmission and/or as any other planetary coupling transmission. The transmission device, for example the epicyclic transmission stage, for example the planetary coupling transmission or the first and the second planetary transmission, can have the first and the second input side and the first and the second output side. The transmission device, for example the epicyclic transmission stage, for example the planetary coupling transmission or the first and the second planetary transmission, can have two different stationary transmission ratios. As a result, the four degrees of freedom can advantageously be implemented. The different stationary transmission ratios advantageously enable different transmission ratios and/or modes of the drive device, for example while enabling a compact construction. Furthermore, the above-mentioned advantages of the drive device can be implemented. In other words, the transmission device, for example the epicyclic transmission stage, for example the planetary coupling transmission, can have a total of four mechanical interfaces, for example the input and the output sides, for example the inputs and the outputs. Specifically, the total of four mechanical interfaces, for example the input and the output sides, for example the inputs and the outputs, can have four shafts leading to the outside.

The first input side of the transmission device, for example of the epicyclic transmission stage, for example of the planetary coupling transmission or of the first and the second planetary transmission, can be connected to the input shaft. The drive unit and/or the first energy machine can be connected by or through the input shaft to the first input side of the transmission device, for example of the epicyclic transmission stage, for example of the planetary coupling transmission or of the first and the second planetary transmission. The second input side of the transmission device, for example of the epicyclic transmission stage, for example of the planetary coupling transmission or of the first and the second planetary transmission, can be connected to the second energy machine. The first output side of the transmission device, for example of the epicyclic transmission stage, for example of the planetary coupling transmission or of the first and the second planetary transmission, can be connected to the dual-clutch transmission, for example to the third input side of the dual-clutch transmission, or to an input side of the first and the second shift element.

By combining the dual-clutch transmission with the transmission device, for example the epicyclic transmission stage, for example the planetary coupling transmission or the first and the second planetary transmission, as part of a dual variator, with two output sides, the power to be installed of the energy machines can be reduced, such that the required installation space of the drive assembly can be reduced. It is thereby advantageously possible to achieve a construction of the drive assembly that is simple in design and compact. Specifically, a drive assembly, for example a continuously variable transmission, can be implemented with “2×6”, that is to say 12, seamlessly shiftable (so-called “seamless shifts”) driving ranges or gears. Otherwise, the drive assembly has the advantages mentioned above.

In a design embodiment of the disclosure, the drive assembly or the transmission device, for example the epicyclic transmission stage, for example the planetary coupling transmission or the first and the second planetary transmission, comprises the third and the fourth shift element. The third and/or the fourth shift element are connectable or connected on the output side, for example optionally, to the dual-clutch transmission, for example to the third input side or to the input side of the first and the second shift element. Specifically, the third or the fourth shift element is connectable or connected on the output side to the dual-clutch transmission, for example to the third input side or to the input side of the first and the second shift element. The third shift element can be connectable or connected to the first output side, and/or the fourth shift element can be connectable or connected to the second output side. Alternatively or additionally, the third shift element can be designed as and/or comprise the first output side, and the fourth shift element can be designed as and/or comprise the second output side. The transmission device, for example the epicyclic transmission stage, for example the planetary coupling transmission or the first and the second planetary transmission, can be connectable or connected optionally by way of or through the third or the fourth shift element to the dual-clutch transmission, for example to the third input side of the dual-clutch transmission. Alternatively or additionally, the first or the second output side of the transmission device, for example of the epicyclic transmission stage, for example of the planetary coupling transmission or of the first and the second planetary transmission, can be connectable or connected optionally by way of or through the third or the fourth shift element to the dual-clutch transmission, for example to the third input side of the dual-clutch transmission. The first output side of the transmission device, for example of the epicyclic transmission stage, for example of the planetary coupling transmission or of the first and the second planetary transmission, can be connectable or connected by way of or through the third shift element to the dual-clutch transmission, for example to the third input side of the dual-clutch transmission. The second output side of the transmission device, for example of the epicyclic transmission stage, for example of the reduced planetary transmission or of the first reduced planetary transmission, can be connectable or connected to the dual-clutch transmission, for example to the third input side of the dual-clutch transmission, by way of or by the fourth shift element. Advantageously, owing to the, for example optional, connection and/or coupling, for example of the first or second output side, of the transmission device, for example of the epicyclic transmission stage, for example of the planetary coupling transmission or of the first and second planetary transmission, by means of the third and/or fourth shift element to the dual-clutch transmission, for example the third input side of the dual-clutch transmission, different modes of the transmission device and/or the direction of rotation of the first and second output sides can be set and/or adjusted.

In a refinement of the disclosure, the drive assembly comprises a set of power electronics, wherein, with the set of power electronics, for example electrical power and/or electrical energy is transmissible between the first and/or the second energy machine and/or the energy store. The set of power electronics can be configured to set and/or adjust and/or actuate the first and the second energy machine and/or the energy store. Specifically, the set of power electronics can be configured to transmit electrical power and/or electrical energy between the first and/or the second energy machine and/or the energy store. The electrical power and/or electrical energy can be transmissible from the first energy machine to the second energy machine and/or to the energy store, and vice versa. The set of power electronics can comprise an electronic control apparatus and/or an inverter and/or a voltage transformer. During operation, the inverter can convert the voltage and/or energy and/or power of the energy store into a voltage and/or energy and/or power required by the energy machines. This procedure can be reversed for charging the energy store. The electronic control apparatus can comprise a computing unit, a computer, a processor, a memory and/or all of the software, hardware, algorithms, connections, and for example also sensors, which are required for setting and/or adjusting the energy machine. The energy store can be controllable by the electronic control apparatus, alternatively the control unit, in order to store electrical energy and/or power and/or to discharge same to the energy machines. The electronic control apparatus, alternatively the control unit, and/or the energy machines can be electrically connected and/or electrically couplable to the set of power electronics and/or to the energy store. Alternatively, the control unit can be designed as an electronic control apparatus or can comprise the latter and/or take over the tasks of the electronic control apparatus. The control unit and/or the electronic control apparatus can be configured to set and/or to adjust the first and/or second energy machine and/or the energy store, such that the electrical energy or power generated by the first and/or second energy machine and/or the electrical energy or power stored in the energy store is discharged.

In a refinement of the disclosure, the drive assembly comprises a module for reversing the direction of rotation or a transmission stage for reversing the direction of rotation. For example, the module for reversing the direction of rotation or the transmission stage for reversing the direction of rotation is arranged in the power flow between the first and the second energy machine, and/or for example upstream of the transmission device, or is arranged in the power flow downstream of the dual-clutch transmission or is arranged in the power flow between the transmission device and the dual-clutch transmission. The module or the transmission stage for reversing the direction of rotation can be designed as a third planetary transmission. The reversal of the direction of rotation can be implemented at the output or drive output or on the driven side of the third planetary transmission, i.e. for example of a sun, for example a third sun, of the third planetary transmission, by corresponding actuation of one or a plurality of brake devices acting on the third planetary transmission. The module or the transmission stage for reversing the direction of rotation can have a clutch device, for example disposed upstream of the third planetary transmission. Said clutch device enables a reliable transmission of force and torque along the power flow in the region of the module or the transmission stage for reversing the direction of rotation. The clutch device can be connectable or connected on the input side to the input shaft or to the first and/or the second output side. The clutch device can on the driven side be connected for example by a shaft, to the sun, for example the third sun, of the third planetary transmission. The module or the transmission stage for reversing the direction of rotation can be connectable or connected on the input side to the input shaft. The module or the transmission stage for reversing the direction of rotation, for example a planet carrier of the third planetary transmission, for example a third planet carrier of the third planetary transmission, can be connectable or connected to the input shaft. Alternatively, the module or the transmission stage for reversing the direction of rotation can be connectable or connected on the input side to the first and/or the second output side. The module or the transmission stage for reversing the direction of rotation, for example a planet carrier of the third planetary transmission, for example a third planet carrier of the third planetary transmission, can be connectable or connected to the first and/or the second output side.

The module or the transmission stage for reversing the direction of rotation can be connected on the output side or on the driven side to the dual-clutch transmission, for example to the third input side of the dual-clutch transmission. The module or the transmission stage for reversing the direction of rotation, for example the sun, for example the third sun, of the third planetary transmission, can be connected to the dual-clutch transmission, for example to the third input side of the dual-clutch transmission. Alternatively, when the first planetary transmission comprises a first and second sun and a first and second planetary set and a first planet carrier, the module or the transmission stage for reversing the direction of rotation can be connected on the output side or on the driven side to the first input side or to the input side, for example to the third input side, of the dual-clutch transmission. The module for reversing the direction of rotation, or the transmission stage for reversing the direction of rotation, makes it possible to provide different directions of rotation of the drive assembly, for example at the output shaft and/or the travel drive, and thus forward and reverse operation of the work machine, without having to implement different directions of rotation of the epicyclic transmission stage or of the dual-clutch transmission. This alternative to a reverse gear in the dual-clutch transmission advantageously reduces the complexity of the drive assembly. The functionality of the reversal of the direction of rotation can thus be provided in a compact construction and be of particularly quiet design.

In a refinement of the disclosure, a separating clutch is arranged between the drive unit and the transmission device or between the drive unit and the first energy machine. By using the separating clutch between the drive unit and the transmission device or the first energy machine, the drive unit can be decoupled from the drive assembly. As a result, the drive assembly can advantageously be operated in a battery-electric driving range, i.e. for example a hybrid drive of the drive assembly can be realized.

In a refinement of the disclosure, the drive assembly comprises a control unit, the drive assembly being operable with the control unit. Alternatively or additionally, the work machine comprises the control unit, wherein the work machine and/or the drive assembly is operable with the control unit. In other words, the control unit is configured to operate the work machine and/or the drive assembly, for example the drive unit. The control unit can be connected to the first and/or the second energy machine and/or the drive unit for signalling, and/or operatively coupled thereto and/or connected thereto for transmitting signals and/or carrying data. The control unit can be configured to receive one or more rotational speed signals and/or torque signals from the drive assembly, for example from rotational speed and/or torque sensors of the drive assembly, and/or from the first and/or the second energy machine and/or from the drive unit. The control unit can be configured to determine a rotational speed and/or a torque with the rotational speed signal and/or the torque signal. The control unit can be configured to set and/or adjust the rotational speed and/or the torque of the drive assembly, for example of the first and/or second energy machine and/or to the drive unit, for example to set and/or adjust a specifiable rotational speed and/or a specifiable torque. Further embodiments of the control unit are described above and below.

In a refinement of the disclosure, the input shaft is connected to a first power output. The drive unit and/or the first energy machine can be connected to the input shaft. The drive unit and/or the first energy machine can be connectable or connected to the first power output via the or by the input shaft. The first power output can comprise a power take-off unit, or be designed as a power take-off unit. The power take-off unit can comprise a power take-off transmission and/or a power take-off shaft. The drive unit and/or the first energy machine can be connectable or connected to the first power output, for example to the power take-off unit, for example to the power take-off transmission and/or the power take-off shaft, for example via the input shaft. The first power output, for example the power take-off unit, for example the power take-off transmission and/or the power take-off shaft, is drivable with the drive unit and/or the first energy machine. The control unit can be configured to set and/or adjust the rotational speed of the first power output.

The drive assembly can have one passage or a plurality of passages, for example one or more central passages, for the input shaft. The passage or the passages, for example the central passage or passages, can be designed as one or more shaft leadthroughs, for example one or more central shaft leadthroughs, for the input shaft.

The transmission device and/or the dual-clutch transmission and/or the starting module and/or the module for reversing the direction of rotation can thus have one or a plurality of shaft leadthroughs, for example one or a plurality of central shaft leadthroughs, for the input shaft. Specifically:
the first and/or the second and/or the third and/or the fourth and/or the fifth and/or any further shift element and/or the first and the second transmission input shaft, and/or
the transmission device, for example the epicyclic transmission stage, for example the first reduced planetary transmission, for example the suns thereof, and/or
the first and/or the second transmission stage, and/or the further shafts
the clutch device and/or the separating clutch
can each have passages, for example shaft leadthroughs, for the input shaft. As a result, a compact and/or modular and/or structurally simple design of the drive assembly, for example of the first power output, can advantageously be achieved.

The disclosure furthermore relates to a work machine, comprising a drive assembly, for example a drive assembly according to one or more embodiments disclosed herein. The work machine can be a construction machine or a towing vehicle, for example an agricultural towing vehicle, for example a tractor or agricultural tractor. The work machine has the above-described advantages of the drive assembly. The work machine comprises the drive assembly. The drive assembly is designed for driving the work machine. The work machine can comprise one, two or more axles. The work machine can be drivable with a rotational speed and/or force and/or a torque of the drive unit.

The control unit can be configured for controlling, by open-loop and/or closed-loop control, for example setting and/or adjusting, the work machine, for example the drive unit. The work machine can comprise an input and output unit. The control unit can be connected to the input and output unit for signalling, and/or operatively coupled thereto and/or connected thereto for transmitting signals and/or carrying data, and/or can be controllable and/or settable and/or adjustable with the input and output unit. The input and output unit can be integrated in the control unit, or vice versa. The operator of the work machine can set and/or adjust a speed of the work machine, for example, with the or by the input and output unit. The control unit can be configured to set and/or adjust the first and/or the second energy machine and/or the stator, for example in such a way that they are electrically driven.

The work machine can, moreover, comprise one or more auxiliary units, for example a pump and/or a cooler, etc. The auxiliary units can be part of the hydraulic system of the drive assembly. The work machine can comprise the first power output, for example the power take-off unit. The control unit can be configured to set and/or adjust and/or control the drive assembly and/or the work machine by means of a driving signal and to set and/or adjust, for example to increase or reduce, a speed of the work machine by means of or based on the driving signal. The work machine can comprise the one or more ground-engaging means. The ground-engaging means can support and/or carry the work machine on the ground. A towing vehicle frame of the work machine can be supported on the ground-engaging means. The ground-engaging means can be wheels or tracks or chains. For example, the ground-engaging means can be front wheels and rear wheels. The work machine can comprise a speed sensor, for example a rotational speed sensor, for detecting a speed of the work machine. Specifically, the control unit can be configured to set and/or to adjust and/or to control a force and/or a torque and/or a rotational speed of the drive unit and/or of the first and/or the second energy machine by means of the driving signal or a plurality of driving signals.

The shift elements, for example the valves or valve devices or actuators thereof, and/or the drive unit and/or the first power output, for example the power take-off unit, and/or the first and/or the second energy machine and/or the energy store and/or the set of power electronics can be controllable and/or settable and/or adjustable, for example controllable, by open-loop and/or closed-loop control, by means of the control unit. The control unit can transmit and/or receive signals for controlling the operation of the drive assembly and/or the work machine. Expediently, the signals can be provided via a suitable data communication network, for example one which complies with the ISOBUS and/or CAN standard. The control unit can be designed as an electronic module, an embedded system, a computing unit, a computer, as a module for open-loop and/or closed-loop control of the drive assembly and/or the work machine. The control unit can comprise one or more processors, a memory and/or all of the software, hardware, algorithms, connections, and for example also sensors, that are required for the open-loop and/or closed-loop control of the drive assembly and/or the work machine. Methods can take the form of a program or algorithm which can be executed on and/or by the control unit. The control unit can comprise any apparatus that analyses data from various sensors, compares data, and makes the decisions necessary to control, by open-loop and/or closed-loop control, and/or to carry out the operation of the drive assembly and/or the work machine, and the necessary tasks for controlling, by open-loop and/or closed-loop control, the operation of the drive assembly and/or the work machine. The control unit can be connected to the components of the drive assembly and/or the work machine, i.e. for example to the shift elements, for example the valves or valve devices or actuators thereof, and/or to the drive unit and/or to the first power output, for example the power take-off unit, and/or the first and/or second energy machine and/or to the energy store and/or the set of power electronics and/or the sensors for signalling and/or operatively coupled thereto and/or connected for transmitting signals and/or for carrying data. Connected for signalling and/or operatively coupled and/or connected for transmitting signals and/or for carrying data can be understood to mean, inter alia, that signals and/or data can be exchanged between the connected components and the control unit. Signals can, for example, be received and sent, and/or processed and/or handled, by the control unit. The connection between the control unit and the parts or components of the drive assembly and/or of the work machine can be implemented by wire, i.e. for example using cables, and/or in a wireless manner, i.e. by radio, for example using Bluetooth or WLAN. The connection between the control unit and the parts or components of the drive assembly and/or of the work machine can be realized, for example, by a local network (LAN), a radio access network (RAN), a Metropolitan Area Network (MAN), a Wide Area Network (WAN), Worldwide Interoperability for Microwave Access (WIMAX), or a wireless local area network (WLAN). Communication can take place, for example, by means of Isobus, CAN bus, or the like. The control unit can be connected directly to an input and output unit, for example to the input and output unit arranged in a cab of the work machine, by means of which data entered by an operator can be transmitted to the control unit, or data can be received from the latter and output. The control unit can be integrated in the input and output unit, or vice versa.

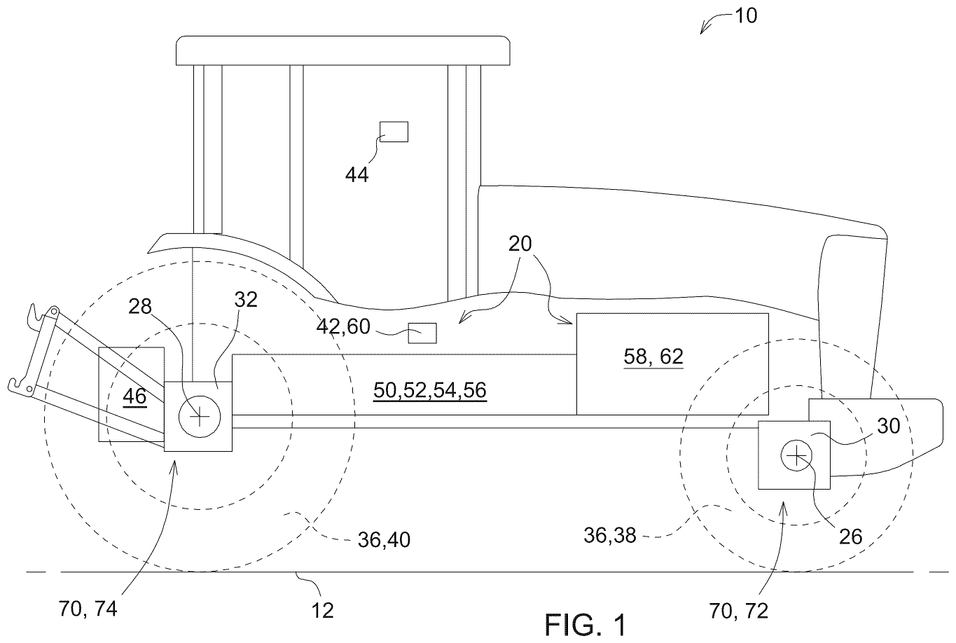

FIG. 1 shows a schematic illustration of a first example embodiment of a work machine 10 according to the disclosure, here an agricultural towing vehicle or tractor or agricultural tractor, having a drive assembly 20 according to the disclosure. The work machine 10 is drivable by the drive assembly 20. The drive assembly 20 comprises a transmission device 50 and a dual-clutch transmission 52 mounted in the power flow downstream of the transmission device 50, wherein at least one gear of the dual-clutch transmission is in the form of a winding path gear. The drive assembly 20 furthermore comprises a first and second energy machine 54, 56 and an input shaft 86 and an output shaft 88.

The work machine 10, or for example the drive assembly 20, comprises a first vehicle axle 26 and a second vehicle axle 28. The first vehicle axle 26 can be a front axle, and the second vehicle axle 28 can be a rear axle. Moreover, the first vehicle axle 26 can be designed as a steerable axle. The work machine 10 can have one or more ground-engaging means 36, in this case in the form of wheels 38, 40, which engage with an underlying surface 12 in order to transmit drive forces and/or by way of which the work machine 10 is supported on the underlying surface 12. The work machine 10, for example the drive assembly 20, can comprise a travel drive 70, for example a front-axle drive 72 and a rear-axle drive 74. The travel drive 70 can comprise the first vehicle axle 26 and/or the second vehicle axle 28 and/or a first differential 30 and/or a second differential 32 and/or the one or more ground-engaging means 36. The front-axle drive 72 can comprise the first vehicle axle 26, and/or the first differential 30, i.e. for example a front-axle differential, and/or the one or more ground-engaging means 36. The rear-axle drive 74 can comprise the second vehicle axle 28, and/or the second differential 32, i.e. for example a rear-axle differential, and/or the one or more ground-engaging means 36. The first vehicle axle 26 can be connected to the first differential 30. The second vehicle axle 28 can be connected to the second differential 32.

The output shaft 88 can be connected to the propulsion drive 76, for example to the first and/or the second differential 30, 32, or for example only to the second differential 32. The output shaft 88 can be connected to the second vehicle axle 28 via the second, or with the second, differential 32. A force and/or a torque and/or a rotational speed can be transmissible from the drive output 54 to the first and/or the second vehicle axle 26, 28, and thus for example to the ground-engaging means 36, via the first, or with the first, differential 30 and/or via the second, or with the second, differential 32. The drive assembly 20 or the work machine 10 can comprise a drive unit 58. The drive unit 58 can be connectable or connected to the input shaft 86. With the drive assembly 20, for example the drive unit 58, a rotational movement and/or force and/or a torque and/or a rotational speed can be generable and can be transmissible, for example via the transmission device 50 and the dual-clutch transmission 52, to the output shaft 88, to the first and/or second vehicle axle 26, 28. The first and/or the second vehicle axle 26, 28 convert the rotational movement and/or force and/or the torque and/or the rotational speed into a rotational movement and/or force and/or a torque and/or rotational speed of one or more ground-engaging means 36, and thus into thrust of the work machine 10. The work machine 10 can, moreover, comprise a towing vehicle frame. The towing vehicle frame can for example be supported by the ground-engaging means 36 suspended on the first and/or the second vehicle axle 28, 30, for example the wheels 38, 40. Specifically, a first pair of wheels 38 are arranged on the first vehicle axle 26, and a second pair of wheels 40 on the second vehicle axle 28. Here, the diameters of the wheels 38, 40 may differ; for example, the diameter of the first pair of wheels 38 may be smaller than the diameter of the second pair of wheels 40. Alternatively, the ground-engaging means 36 can also be designed and arranged as tracks or chains.

The work machine 10, for example the drive assembly 20, can comprise a first power output 46. The first power output 46 can comprise a power take-off unit 108. The first power output 46 can be provided for driving a working implement (not shown) which is attachable to the work machine 10 via an interface (e.g. three-point interface). The work machine 10, for example alternatively or additionally the drive assembly 20, can comprise a control unit 42 and/or an input and output unit 44. The control unit 42 can be connected to the input and output unit 44 for signalling, and/or operatively coupled thereto and/or connected thereto for transmitting signals and/or carrying data. Specifically, the control unit 42 can be connected directly to the input and output unit 44 arranged in a cab of the work machine 10, by means of which data entered by an operator can be transmitted to the control unit 42, or data can be received from the latter and output. The drive assembly 20, and/or for example the work machine 10, can be settable and/or adjustable with the control unit 42. The control unit 42 is connected to the drive unit 58 and/or to the first and/or the second energy machine 54, 56 for signalling, and/or operatively coupled thereto and/or connected thereto for transmitting signals and/or carrying data.

The control unit 42 is configured to set and/or adjust the rotational speed and/or the torque and/or the force of the drive assembly 20, for example the drive unit 58 and/or the first and/or second energy machine 54, 56, for example to actuate the latter and/or to control the latter, by open-loop and/or closed-loop control. The control unit 42 can be configured to set and/or adjust a specifiable rotational speed and/or a specifiable torque and/or a specifiable force of the drive assembly 20, for example the drive unit 58 and/or the first and/or second energy machine 54, 56, for example to actuate the latter and/or to control the latter, by open-loop and/or closed-loop control. The control unit 42 can be configured to set and/or adjust the drive assembly 20, for example alternatively or additionally the work machine 10, in order to set and/or to adjust, for example to control, by open-loop and/or closed-loop control, the rotational speed and/or the torque and/or the force of the drive unit 58.

Moreover, the work machine 10, alternatively or additionally the drive assembly 20, can comprise a set of power electronics 60 in order to transmit the electrical power or energy between the first and/or the second energy machine 54, 56 and an energy store 62, here, for example, a battery (rechargeable battery). The control unit 42 can be connected to the set of power electronics 60 and to the energy store 62 for signalling, and/or operatively coupled thereto and/or connected thereto for transmitting signals and/or carrying data. The energy store 62 can supply the electrically driven components of the drive assembly 20 with currents or voltages of suitable frequency and amplitudes in order to provide desired output rotational speeds or torques for the first power output 46 and/or the drive assembly 20.

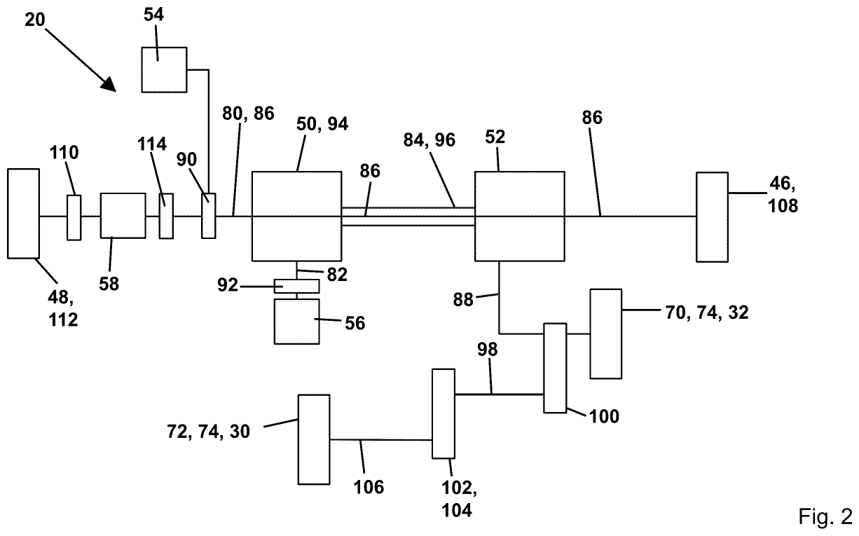

FIG. 2 shows a schematic illustration of a first example embodiment of the drive assembly 20 according to the disclosure. The drive assembly 20 shown in FIG. 2 corresponds substantially to the drive assembly 20 shown in FIG. 1, and therefore only details and/or points of differentiation will be discussed below. The work machine 10 illustrated in FIG. 1 can comprise the drive assembly 20 illustrated in FIG. 2. The drive assembly 20 for the work machine 10 comprises the transmission device 50 with a first and a second input side 80, 82, and a first and a second output side 84, 96, and the dual-clutch transmission 52.

The dual-clutch transmission 52 is connectable, or connected, to the first and/or the second output side 84, 96, for example optionally to the first or the second output side 84, 96, of the transmission device 50, for example by in each case one further shaft, which can for example be designed as a hollow shaft, and/or by a shift element. The drive assembly 20 furthermore comprises the input shaft 86 and the output shaft 88. The input shaft 86 can be connectable or connected to the first input side 80. The first energy machine 54 is connected to the input shaft 86. The first energy machine 54 can be connected to the input shaft 86 directly or via a or with a first or by a first transmission stage 90 and/or a further shaft. In addition, the drive unit 58 can be connectable or connected to the input shaft 86. The second energy machine 56 is connected to the second input side 82. The second energy machine 56 can be connected to the second input side 82 directly or via a or with a second or by a second transmission stage 92 and/or a further shaft. Moreover, a rotating speed and/or a direction of rotation of the transmission device 50 is settable and/or adjustable and/or actuable, for example a rotating speed and/or a direction of rotation of the first and/or the second output side 84, 96 is settable and/or adjustable and/or actuable by the second energy machine 56. In other words, a rotating speed and/or a direction of rotation, and/or for example a rotation, of the second energy machine 56 can be settable and/or adjustable and/or actuable, for example in such a manner that a rotating speed and/or a direction of rotation, and/or for example a rotation, of the transmission device 50, for example of the first and/or the second output side 84, 96, is settable and/or adjustable and/or actuable.

The transmission device 50 can be designed as an epicyclic transmission stage 94. The transmission device 50, for example the epicyclic transmission stage 94, can be designed as and/or comprise a planetary coupling transmission 118.

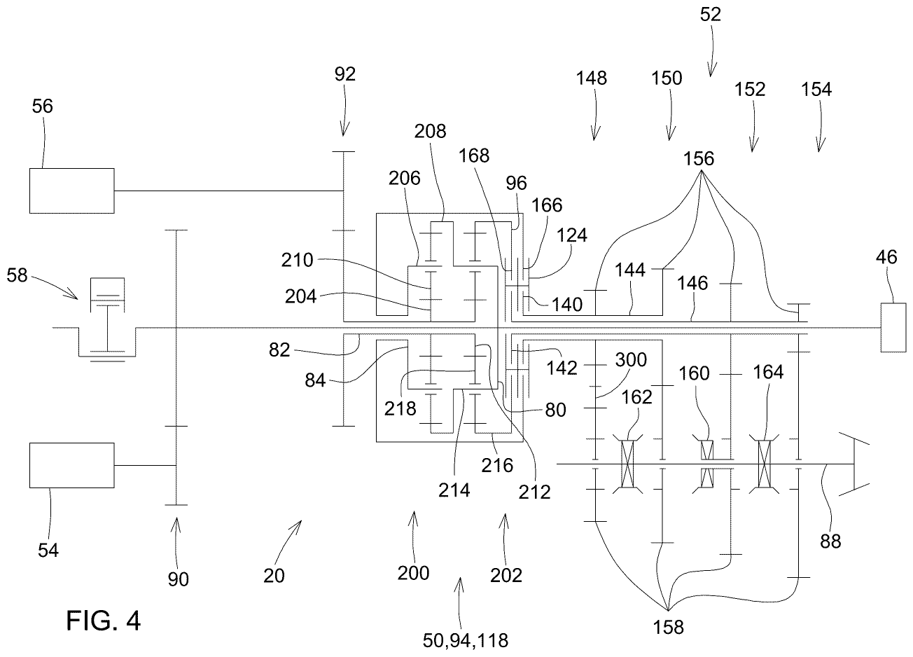

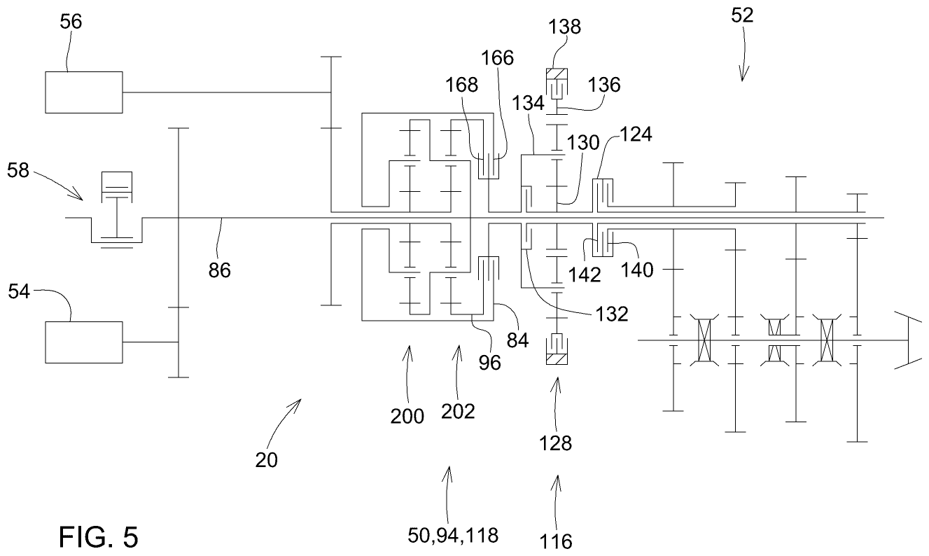

The transmission device 50, for example the epicyclic transmission stage 94, for example the planetary coupling transmission 118, comprises a first and a second planetary transmission 200, 202. The first and the second planetary transmission 200, 202 are coupled to one another (see FIGS. 4 and 5).

The transmission device 50, for example the epicyclic transmission stage 94, for example the planetary coupling transmission 118 or the first and the second planetary transmission 200, 202, can have the first and the second input side 80, 82 and the first and the second output side 84, 96. In addition, the input shaft 86 is connected to the first power output 46.

The dual-clutch transmission 52 is connectable or connected on the driven side to the output shaft 88. The output shaft 88 can, moreover, be connectable or connected to the travel drive 70, for example to the rear-axle drive 74, for example to the first and/or second differential 30, 32. Specifically, the output shaft 88 can be connectable or connected to a layshaft 98, for example by way of a or by a third transmission stage 100, for example a further spur gear stage or a further gearwheel pair or three or more gearwheels or a further planetary transmission or any other transmission. Moreover, the countershaft 98 can be connectable or connected to the travel drive 70, for example to the front-axle drive 72, for example to the first differential 30. The countershaft 98 can be connectable or connected to a further shaft 106 with a fourth or via a fourth transmission stage 102, for example a further cylindrical gear stage or a further gearwheel pair, or three or more gearwheels, or a further planetary transmission or another transmission, and/or a further shift element 104. The drive assembly 20 can, moreover, comprise the first power output 46.

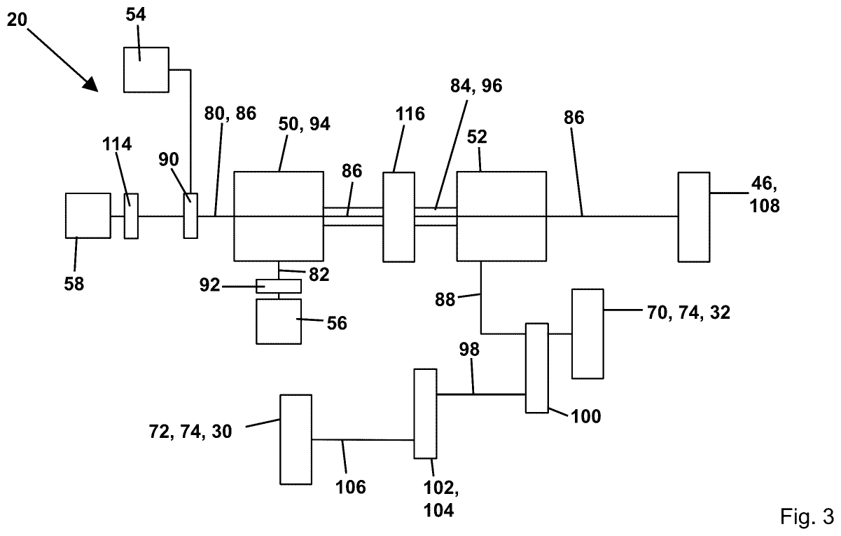

The drive unit 58 and/or the first energy machine 54 can be connectable or connected to the first power output 46. Specifically, the drive unit 58 and/or the first energy machine 54 can be connectable or connected to the first power output 46 via the or by the input shaft 86. The input shaft 86 can be connectable or connected to the first power output 46, for example, with a further shift element (not shown). The first power output 46 can comprise a power take-off unit 108. The power take-off unit 108 can comprise a power take-off transmission and/or a power take-off shaft. The power take-off unit 108, for example the power take-off transmission, can be connected on the drive side to the input shaft 86. Moreover, the power take-off unit 108, for example the power take-off transmission, can be connectable or connected on the driven side to the power take-off shaft. The transmission device 50 and/or the dual-clutch transmission 52 can have a passage, for example a central passage, for the input shaft 86. The drive assembly 20 can, moreover, comprise a second power output 48. The drive unit 58 and/or the first energy machine 54 can be connectable or connected to the second power output 48. Specifically, the drive unit 58 and/or the first energy machine 54 can be connectable, or connected, to the second power output 48 by way of a further shaft and/or the input shaft 86 and/or a further shift element 110. The second power output 48 can comprise a further power take-off unit 112. The further power take-off unit 112 can comprise a further power take-off transmission and/or a further power take-off shaft. FIGS. 2 to 3 schematically describe the torque flow and/or power flux of the drive assembly 20 to the output shaft 88.

The drive assembly 20 can furthermore comprise the drive unit 58. A separating clutch 114 can be arranged between the drive unit 58 and the transmission device 50 or between the drive unit 58 and the first energy machine 54. A rotational speed and/or a torque and/or a force can thereby optionally be introducible into the drive assembly 20, for example the transmission device 50, by the drive unit 58. The transmission device 50 can be arranged in the torque flow and/or power flow upstream of the dual-clutch transmission 52.

FIG. 3 shows a schematic illustration of the second example embodiment of the drive assembly 20 according to the disclosure. The drive assembly 20 shown in FIG. 3 corresponds substantially to the drive assembly 20 shown in FIGS. 1 and 2, and therefore only details and/or points of differentiation will be discussed below. The work machine 10 illustrated in FIG. 1 can comprise the drive assembly 20 illustrated in FIG. 3. The drive assembly 20 comprises a module 116 for reversing the direction of rotation. With the module 116 for reversing the direction of rotation, a direction of rotation of the first and/or the second output side 84, 96 and/or of the output shaft 88 can be reversible. In the present case, the module 116 for reversing the direction of rotation is arranged in the power flow between the transmission device 50 and the dual-clutch transmission 52. Alternatively, however, the module 116 for reversing the direction of rotation can also be arranged in the power flow between the first and the second energy machines 54, 56 or downstream of the dual-clutch transmission 52.

FIG. 4 shows a schematic illustration of the third example embodiment of the drive assembly 20 according to the disclosure. The drive assembly 20 shown in FIG. 4 corresponds substantially to the drive assembly 20 shown in FIGS. 1 to 3, and therefore only details and/or points of differentiation will be discussed below. The work machine 10 illustrated in FIG. 1 can comprise the drive assembly 20 illustrated in FIG. 4. The dual-clutch transmission 52 comprises a first and second shift element 140, 142. The first shift element 140 is connectable, or connected, to a first transmission input shaft 144, and the second shift element 142 is connectable, or connected, to a second transmission input shaft 146. The dual-clutch transmission 52 comprises four cylindrical gear stages 148, 150, 152, 154 each having a fixed gear 156 arranged on the first or second transmission input shaft 144, 146 for conjoint rotation and each having a shift gear 158 arranged rotatably on the output shaft 88. The dual-clutch transmission 52 has four cylindrical gear stages 148, 150, 152, 154 for setting up gear ratio stages. Specifically, a first cylindrical gear stage 148 and a second cylindrical gear stage 150 each have the fixed gear 156 on the first transmission input shaft 144 and each have the shift gear 158 on the output shaft 88. A third cylindrical gear stage 152 and a fourth cylindrical gear stage 154 can each have the fixed gear 156 on the second transmission input shaft 146 and can each have the shift gear 158 on the output shaft 88.

The dual-clutch transmission 52 moreover comprises the first coupling element 160. The first coupling element 160 is arranged on the output shaft 88 between the second and the third cylindrical gear stages 150, 152, and is mounted on the output shaft 88. The two shift gears 158 of the second and third cylindrical gear stages 150, 152 can be connected for conjoint rotation to the first coupling element 160 in such a way that the first and the second transmission input shafts 144, 146 are placed in dependence on one another and a winding path gear ratio stage is formed. The second coupling element 162 can be arranged between the first and the second cylindrical gear stages 148, 150 on or at the output shaft 88. The third coupling element 164 can be arranged between the third and the fourth cylindrical gear stages 152, 154 on or at the output shaft 88. The shift gear 158 of the first cylindrical gear stage 148 can be connected for conjoint rotation to the output shaft 88 by the second coupling element 162. The shift gear 158 of the fourth cylindrical gear stage 154 can be connected for conjoint rotation to the output shaft 88 by the third coupling element 164.

On the driven side, the output shaft 88 is assigned to the dual-clutch transmission 52. The dual-clutch transmission is connected on the input side to the first output side 84. The first and/or the second transmission input shaft 144, 146 are designed as hollow shafts. The input shaft 86 is designed as a solid shaft. The second transmission input shaft 146 is arranged and/or mounted, for example arranged and/or mounted in a freely rotatable manner, in the first transmission input shaft 144, and the input shaft 86 is arranged and/or mounted, for example arranged and/or mounted in a freely rotatable manner, in the second transmission input shaft 146.

The transmission device 50, for example the epicyclic transmission stage 94, for example the planetary coupling transmission 118 or the first and the second planetary transmission 200, 202, comprises a third and a fourth shift element 166, 168. The third and the fourth shift element 166, 168 are connectable, or connected, on the input side to the transmission device 50, for example to the epicyclic transmission stage 94, for example to the planetary coupling transmission 118 or to the first and the second planetary transmission 200, 202. The third and the fourth shift elements 166, 168 are designed as clutches.

The first planetary transmission 200 comprises a first sun 204 and a first planet carrier 206 and a first ring gear 208 and one or a plurality of, for example three, first planets 210.

The second planetary transmission 202 comprises a second sun 212 and a second planet carrier 214 and a second ring gear 216 and one or a plurality of, for example three, second planets 218. The first ring gear 208 is connected, for example coupled, to the second planet carrier 214. Moreover, the first and the second sun 204, 212 are connected, for example coupled.

The drive unit 58 and/or the first energy machine 54 can be connected to the second planet carrier 214 by way of, or through, the input shaft 86. The transmission device 50, for example the epicyclic transmission stage 94, for example the planetary coupling transmission 118 or the first and the second planetary transmission 200, 202, can be connectable, or connected, for example optionally, through the third shift element 166 to the first planet carrier 206, or through the fourth shift element 168 to the second ring gear 216.

The first input side 80 of the transmission device 50, for example of the epicyclic transmission stage 94, for example the planetary coupling transmission 118 or the first and the second planetary transmission 200, 202, can be the second planet carrier 214. Alternatively or additionally, the first input side 80 can be connectable, or connected, to the second planet carrier 214. The second planet carrier 214 can be connectable, or connected, to the input shaft 86. The second planet carrier 214 can be connectable, or connected, through a, or by a, further shaft to the input shaft 86.

The second input side 82 of the transmission device 50, for example of the epicyclic transmission stage 94, for example the planetary coupling transmission 118 or the first and the second planetary transmission 200, 202, can be connectable or connected to the second energy machine 56. The second energy machine 56 can be connectable, or connected, to the first and the second sun 204, 212. The second input side 82 can be the first and the second sun 204, 212. Alternatively or additionally, the second input side 82 can be connectable, or connected, to the first and the second sun 204, 212. The first and the second sun 204, 212 can be connectable, or connected, to the second energy machine 56 through or by a shaft and/or the second transmission stage 92.

The first output side 84 of the transmission device 50, for example of the epicyclic transmission stage 94, for example the planetary coupling transmission 118 or the first and the second planetary transmission 200, 202, can be the first planet carrier 206. Alternatively or additionally, the first output side 84 can be connectable, or connected, to the first planet carrier 206. The first planet carrier 206 can be connectable, or connected, to the dual-clutch transmission 52, for example connected to the third input side 124 of the dual-clutch transmission 52, or to an input side of the first and the second shift element 140, 142. The first planet carrier 206 can be connectable, or connected, to the dual-clutch transmission 52, for example to the third input side 124 or to an input side of the first and the second shift element 140, 142 through or by a shaft. The first planet carrier 206 can be connectable, or connected, to the dual-clutch transmission 52, for example to the third input side 124 or to an input side of the first and the second shift element 140, 142, through or by way of the third shift element 166. The third shift element 166 is connected on the input side to the first planet carrier 206 and is connectable or connected on the output side to the dual-clutch transmission 52, for example to the third input side 124 or to an input side of the first and the second shift element 140, 142.

The second output side 96 of the transmission device 50, for example of the epicyclic transmission stage 94, for example the planetary coupling transmission 118 or the first and the second planetary transmission 200, 202, can be the second ring gear 216. Alternatively or additionally, the second output side 96 can be connectable, or connected, to the second ring gear 216. The second ring gear 216 can be connected to the dual-clutch transmission 52, for example connected to the third input side 124 of the dual-clutch transmission 52 or to an input side of the first and the second shift element 140, 142. The second ring gear 216 can be connectable, or connected, to the dual-clutch transmission 52, for example to the third input side 124 or to an input side of the first and the second shift element 140, 142, through or by a shaft. The second ring gear 216 can be connectable, or connected, through or by way of the fourth shift element 168 to the dual-clutch transmission 52, for example to the third input side 124 or an input side of the first and the second shift element 140, 142. The fourth shift element 168 is connected on the input side to the second ring gear 216 and is connectable or connected on the output side to the dual-clutch transmission 52, for example to the third input side 124 or to an input side of the first and the second shift element 140, 142.

A reverse idler gear 300 is arranged, for example in an intervening manner, between the first or the second transmission input shaft 144, 146 and the output shaft 88 of the dual-clutch transmission. The return gear 300 can be arranged between a fixed gear 156 and shift gear 158 of one of the cylindrical gear stages 148, 150, 152, 154. In FIG. 4, the reverse idler gear 300 is arranged in the first spur gear stage 148, for example between the fixed gear 156 and the shift gear 158 of the first spur gear stage 148. As a result, with the dual-clutch transmission 52, it is advantageously possible to realize four forward gears (of which one is a winding path gear) and two reverse gears (of which one is a winding path gear).

FIG. 5 shows a schematic illustration of the fourth example embodiment of the drive assembly 20 according to the disclosure. The drive assembly 20 shown in FIG. 5 corresponds substantially to the drive assembly 20 shown in FIGS. 1 to 4, and therefore only details and/or points of differentiation will be discussed below. The work machine 10 illustrated in FIG. 1 can comprise the drive assembly 20 illustrated in FIG. 5. The first and/or the second output side 84, 96 of the transmission device 50, for example of the epicyclic transmission stage 94, for example of the planetary coupling transmission 118 or of the first and the second planetary transmission 200, 202, is connectable, or connected, by way of the module 116 for reversing the direction of rotation to the dual-clutch transmission 52, for example connectable, or connected, to the third input side 124 or to an input side of the first and the second shift element 140,142 of the dual-clutch transmission 52. The first output side 84 can be connectable, or connected, by way of the, or through the, third shift element 166 to the module 116 for reversing the direction of rotation. The second output side 96 can be connectable, or connected, by way of the, or through the, fourth shift element 168 to the module 116 for reversing the direction of rotation. Specifically, the first and/or the second output side 84 can be connectable, or connected, to a clutch device 132 of the module 116 for reversing the direction of rotation. The first output side 84 can be connectable, or connected, by way of the, or through the, third shift element 166 to the clutch device 132. The second output side 96 can be connectable, or connected, by way of the, or through the, fourth shift element 168 to the clutch device 132. The third and the fourth shift element 166, 168 can be connectable, or connected, to the clutch device 132, for example by way of a, or by a, common shaft.

The module 116 for reversing the direction of rotation is designed as a third planetary transmission 128. Reversing the direction of rotation can be implemented at the output or drive output or on the driven side of the third planetary transmission 128, presently a sun, for example the third sun 130, of the second planetary transmission 128. The dual-clutch transmission 52 is connectable, or connected, for example on the input side, for example the third input side 124 of the dual-clutch transmission 52 or an input side of the first and the second shift element 140, 142, to the third sun 130, for example through or by a further shaft. The clutch device 132 is connected on the output side to a third planet carrier 134. The clutch device 132 is connectable, or connected, on the output side to the third sun 130. A third ring gear 136 of the third planetary transmission 128 is connectable to a brake 138. The dual-clutch transmission 52 does not comprise a reverse idler gear 300.

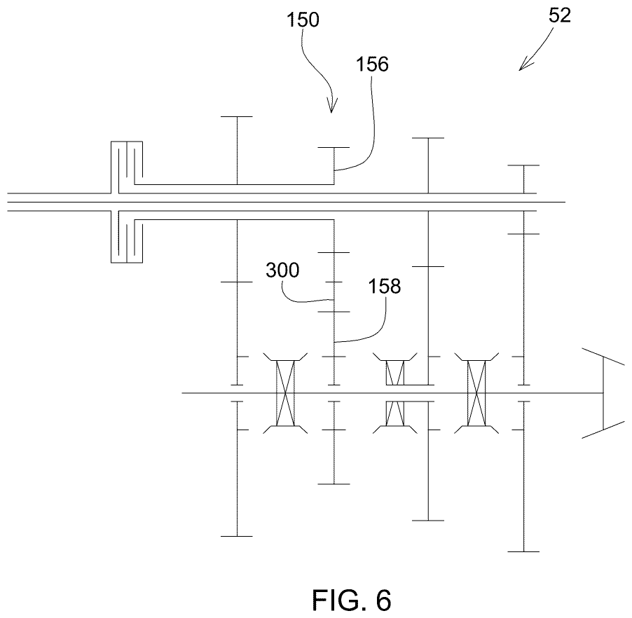

FIG. 6 shows a schematic illustration of a further example embodiment of the dual-clutch transmission 52. The dual-clutch transmission 52 shown in FIG. 6 corresponds substantially to the dual-clutch transmission 52 shown in FIGS. 1 to 5, and therefore only details and/or points of differentiation will be discussed below. The drive assembly 20 illustrated in FIGS. 1 to 5 can comprise the dual-clutch transmission 52 illustrated in FIG. 6. In FIG. 6, the reverse idler gear 300 is arranged in the second spur gear stage 150, for example between the fixed gear 156 and the shift gear 158 of the second spur gear stage 150. As a result, with the dual-clutch transmission 52, it is advantageously possible for three forward gears in the form of single-stage gears and three reverse gears, of which two are in the form of winding path gears, to be realized.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A drive assembly for a work machine, comprising:
a transmission device including a first input side, a second input side, a first output side, and a second output side;
a dual-clutch transmission connected to the transmission device, the dual-clutch transmission including a first shift element connected to a first transmission input shaft, a second shift element connected to a second transmission input shaft, a plurality of cylindrical gear stages each having a fixed gear arranged for conjoint rotation on one of the first or second transmission input shaft, each having a shift gear arranged rotatably on the output shaft, and one of the plurality of cylindrical gear stages having a reverse idler gear;
an input shaft;
an output shaft;
a first energy machine connected to the input shaft;
a second energy machine connected to the second input side; and
a control unit, including a processor and memory, configured to adjust a direction of rotation and a rotating speed of the first output side and the second output side of the transmission device by the second energy machine.

2. The drive assembly of claim 1, further comprising:
a drive unit connected to the input shaft.

3. The drive assembly of claim 1, wherein the transmission device is designed as an epicyclic transmission stage.

4. The drive assembly of claim 3, wherein the epicyclic transmission stage includes a third shift element and a fourth shift element connected to the dual-clutch transmission.

5. The drive assembly of claim 1, further comprising:
a set of power electronics by which electrical power is transmissible between the first energy machine and the second energy machine.

6. The drive assembly of claim 1, further comprising:
a module for reversing the direction of rotation arranged in the power flux between the transmission device and the dual-clutch transmission.

7. The drive assembly of claim 1, further comprising:
a separating clutch is arranged in the power flux between the drive unit and the first energy machine and the transmission device.

8. The drive assembly of claim 1, wherein the input shaft is connected to a first power output.

9. A work machine including a drive assembly, comprising:
a first vehicle axle;
a second vehicle axle;
a plurality of ground engaging apparatus;
a transmission device including a first input side, a second input side, a first output side, and a second output side;
a dual-clutch transmission connected to the transmission device, the dual-clutch transmission including a first shift element connected to a first transmission input shaft, a second shift element connected to a second transmission input shaft, a plurality of cylindrical gear stages each having a fixed gear arranged for conjoint rotation on one of the first or second transmission input shaft, each having a shift gear arranged rotatably on the output shaft, and one of the plurality of cylindrical gear stages having a reverse idler gear;
an input shaft;
an output shaft;
a first energy machine connected to the input shaft;
a second energy machine connected to the second input side; and
a control unit, including a processor and memory, configured to adjust a direction of rotation and a rotating speed of the first output side and the second output side of the transmission device by the second energy machine.

10. The work machine of claim 9, further comprising:
a drive unit connected to the input shaft.

11. The work machine of claim 9, wherein the transmission device is designed as an epicyclic transmission stage.

12. The work machine of claim 11, wherein the epicyclic transmission stage includes a third shift element and a fourth shift element connected to the dual-clutch transmission.

13. The work machine of claim 9, further comprising:
a set of power electronics by which electrical power is transmissible between the first energy machine and the second energy machine.

14. The work machine of claim 9, further comprising:
a module for reversing the direction of rotation arranged in the power flux between the transmission device and the dual-clutch transmission.

15. The work machine of claim 9, further comprising:
a separating clutch is arranged in the power flux between the drive unit and the first energy machine and the transmission device.

16. The work machine of claim 9, wherein the input shaft is connected to a first power output.
